(19) United States
(12) Patent Application Publication
(10) Pub. No.: US 2016/0208691 A1
(43) Pub. Date: Jul. 21, 2016

(54) TURBINE ENGINE WITH BOUNDARY LAYER TURBINE

(71) Applicant: Pavel Villaseca, Calgary (CA)

(72) Inventor: Pavel Villaseca, Calgary (CA)

(21) Appl. No.: 14/597,770

(22) Filed: Jan. 15, 2015

(51) Int. Cl. F02C 3/107

(52) U.S. Cl. CPC F02C 3/107

(57) ABSTRACT

A turbine engine is disclosed herein. The turbine engine includes a compressor section operable to compress fluid. The turbine engine also includes a combustor section positioned downstream of the compressor section and defining a combustion chamber operable to receive the compressed fluid from the compressor section. The turbine engine also includes at least one turbine section positioned downstream of the combustor section and operable to receive combustion gases from the combustion chamber. The turbine section includes a plurality of spaced disks disposed for rotation and each having planar surfaces. The combustion gases are operable to drive the plurality of spaced disks in rotation by engaging the planar surfaces.

### BACKGROUND

1. Field

The present disclosure relates to a turbine engine.

2. Description of Related Prior Art

U.S. Pub. No. 2013/0039744 discloses an INTERNAL COMBUSTION BOUNDARY LAYER TURBINE ENGINE (hereafter BLTE). The embodiment is a flat-disk radial flow turbine engine which is scalable in size and can provide high, medium or low power outputs respectively. The BLTE provides these outputs at much higher efficiency than that of a reciprocating engine or a conventional radial flow turbine engine. This engine offers simple and inexpensive construction with commonly available machine tools. This engine offers the light weight and high power output capability of a continuous burn turbine engine with reduced exhaust flow and reduced emissions. The BLTE application of differentially sized flat blades solves the problem of internal combustion and multi-stage operation for this new category of engine.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A turbine engine includes a compressor section, a combustor section, and a turbine section. The turbine engine includes a compressor section operable to compress fluid. The turbine engine also includes a combustor section positioned downstream of the compressor section and defining a combustion chamber operable to receive the compressed fluid from the compressor section. The turbine engine also includes at least one turbine section positioned downstream of the combustor section and operable to receive combustion gases from the combustion chamber. The turbine section includes a plurality of spaced disks disposed for rotation and each having planar surfaces. The combustion gases are operable to drive the plurality of spaced disks in rotation by engaging the planar surfaces.

### BRIEF DESCRIPTION OF THE DRAWINGS

The detailed description set forth below references the following drawings:

FIG. 1 is a schematic cross-section of a turbine engine incorporating an exemplary embodiment of the present disclosure;

FIG. 2 is a schematic partial cross-section of a combustor section and a turbine section incorporating another exemplary embodiment of the present disclosure;

FIG. 3 is a schematic rear view of the combustor section and the turbine section shown in FIG. 2;

FIG. 4 is a schematic rear view of a combustor section and a turbine section incorporating another exemplary embodiment of the present disclosure; and

FIG. 5 is a schematic and partial cross-section of a turbine engine incorporating another exemplary embodiment of the present disclosure.

### DETAILED DESCRIPTION

A plurality of different embodiments of the present disclosure is shown in the Figures of the application. Similar features are shown in the various embodiments of the present disclosure. Similar features have been numbered with a common reference numeral and have been differentiated by an alphabetic suffix. Similar features in a particular embodiment have been numbered with a common two-digit, base reference numeral and have been differentiated by a leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a new turbine engine having improved efficiency. By replacing turbine blades, or bladed-discs, with planar discs the present turbine engine extracts power more efficiently. More power can be extracted and fuel efficiency can be improved.

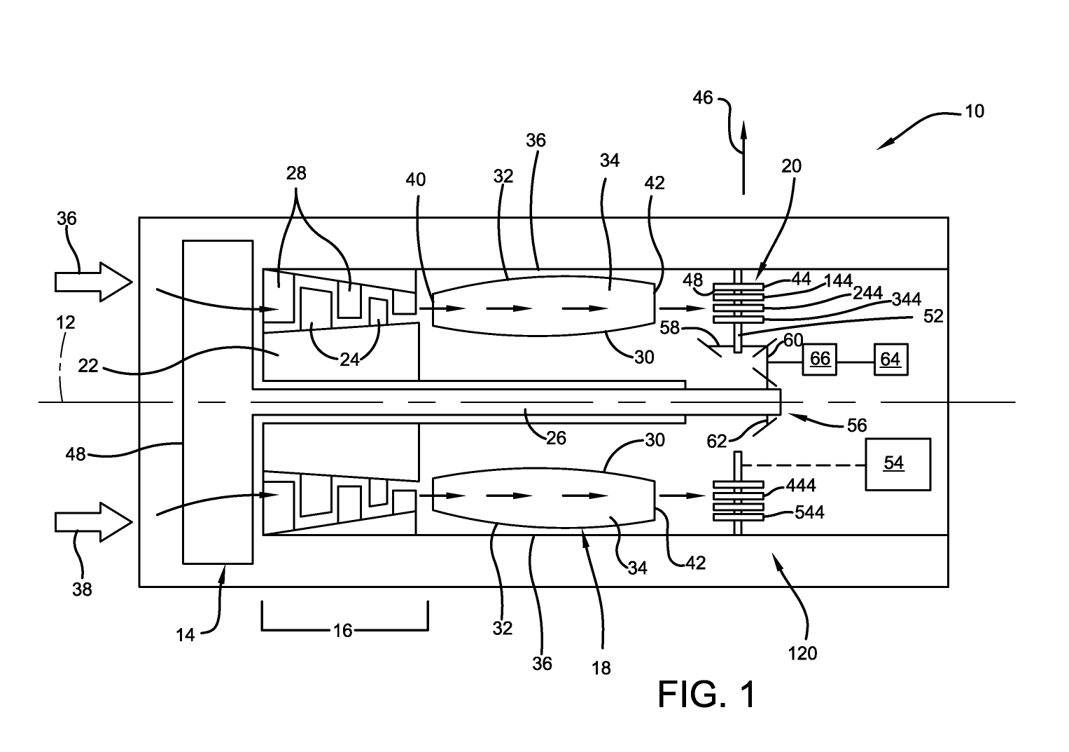

FIG. 1 is a schematic representation of a turbine engine 10. The turbine engine 10 extends along a longitudinal axis 12. As used herein, forms of the terms “radial” and “circumference” as applied to some structure refer to the relationship between the structure and the axis 12. The turbine engine 10 has a generally annular configuration, however other configurations can be practiced in alternative embodiments of the present invention. The exemplary turbine engine 10 includes a fan section 14, a compressor section 16, a combustor section 18, and a turbine section 20. It is also noted that numerous configurations of turbine engines can practiced with the invention. For example, multiple compressor and turbine sections can be incorporated, with intercoolers connected between the compressor stages. All of the various configurations of turbine engines described above and/or known in the art can be practiced in an embodiment of the present disclosure. It is also noted that the present invention can be practiced in various operating environments, such as industrial applications including but not limited to pumping sets for gas and oil transmission lines and electricity generation.

The compressor section 16 includes a rotor 22 having a plurality of compressor blades 24. The rotor 22 is fixed to a rotatable shaft 26. The fan section 14 can also be driven in rotation by the shaft 26. A plurality of compressor vanes 28 is positioned adjacent to the compressor blades 24 to direct the flow of air through compressor section 16.

The combustor section 18 includes an inner combustor liner 30 and an outer combustor liner 32. The liners 30, 32 cooperate with one another to define the inner and outer boundaries of an annular combustion chamber 34. Fuel is introduced into combustion chamber 34 via a plurality of fuel nozzles (not shown). The inner and outer liners 30, 32 are each formed of materials that are capable of withstanding high temperature environments. Materials such as metallic superalloys and inter-metallic materials, and structures such as Lamilloy®.

In operation, air enters the turbine engine 10 in the direction indicated by arrows 36, 38 and passes through the fan section 14. The air stream is then fed into the compressor section 16. The compressed air exiting compressor section 16 is routed into the combustion chamber 34. The compressed air enters the combustion chamber 34 at a forward end 40 of the combustor section 18 and is intermixed with fuel, becoming a combustible air/fuel mixture. The air/fuel mixture is ignited and burned in the combustor section 18, generating combustion gases, a hot gaseous fluid stream. The hot gaseous fluid stream exits an outlet 42 or exit port at an aft end of the combustor section 18 and is fed into the turbine section 20. The turbine section 20 is operable to extract energy from the combustion gases to generate power. The power can be applied to power the turbine engine 10 and/or can be applied to other uses.

At least one turbine section 20 is positioned downstream of the combustor section 18. The exemplary embodiment also includes a second turbine section 120. Both turbine sections 20, 120 are operable to receive combustion gases from the combustion chamber 34. The turbine section 20 includes a plurality of spaced disks 44, 144, 244, 344 disposed for rotation about an axis 46. The turbine section 120 includes a plurality of spaced disks 444 and 544, for example, disposed for rotation. Each disc has a planar surfaces receiving combustion gases. For example, the disc 44 includes a surface 48. The combustion gases are operable to drive the plurality of spaced disks in rotation by engaging the planar surfaces. Rotation of the discs generates rotational power.

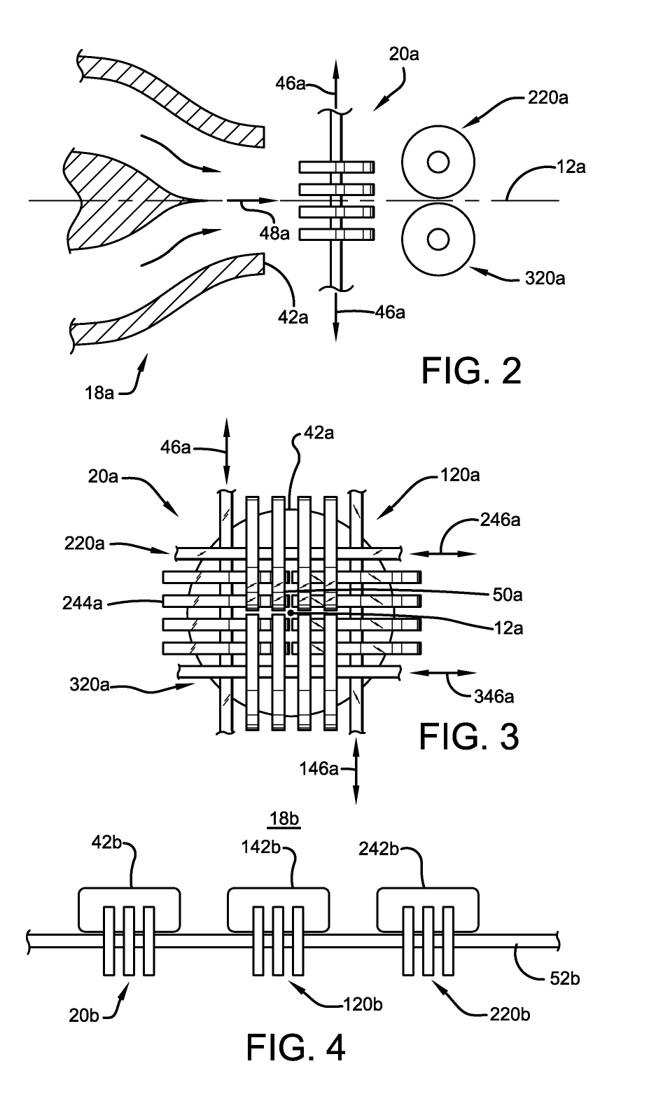

FIGS. 2 and 3 show a combustor section 18a having an outlet 42a and centered on an axis 12a. A plurality of turbine sections 20a, 120a, 220a, and 320a each include a respective plurality of spaced disks disposed for rotation. The turbine sections 20a, 120a, 220a, 320a are arranged to rotate on different axes. The discs of the turbine section 20a are disposed to rotate about an axis 46a. The discs of the turbine section 120a are disposed to rotate about an axis 146a. The axes 46a and 146a are spaced from and parallel to one another. The discs of the turbine section 220a are disposed to rotate about an axis 246a. The discs of the turbine section 320a are disposed to rotate about an axis 346a. The axes 246a and 346a are spaced from and parallel to one another. The axes 46a and 146a are transverse to the axes 246a and 346a. The combustion gases move in a direction referenced at arrow 48a and the axes 46a and 146a are spaced from the axes 246a and 346a along the direction 48a. The combustor section 18a defines a single and continuous exit port 42a. The radial edges of the plurality of spaced disks are substantially centered on the exit port. For example, as best shown in FIG. 3, the radial edge 50a of the disc 244a is substantially aligned on a center of the exit port 42a.

Referring now to FIG. 4, an embodiment can include a combustor section 18b defining a plurality of exit ports 42b, 142b, and 242b. A plurality of turbine section 20b, 120b, 220b can be respectively positioned at each of the plurality of exit ports and each can include a respective plurality of spaced disks disposed for rotation. Each of the plurality of turbine section 20b, 120b, 220b can be mounted on a common shaft 52b. Each of the exit ports 42b, 142b, 242b can have a rectangular perimeter.

The rotational power generated by a turbine section can be applied to generate electrical power. Referring again to FIG. 1, power from the turbine section 120 can be converted to electrical power and stored in a battery or a network of batteries referenced at 54. The rotational power generated by a turbine section can also be applied to power the compressor section 16. A linkage 56 can be operable to transmit rotation between the compressor section 16 and the turbine section 20. The linkage 56 can include a first gear 58 mounted for rotation on a shaft 52 of the turbine section 20. The linkage 56 can also include a second gear 60 meshed with the first gear 58 and rotating at a perpendicular to the first gear 58. The linkage 56 can also include a third gear 62 meshed with the second gear 60 and rotating in parallel to the second gear 60. The third gear 62 can be mounted for rotation on the shaft 26. An embodiment can also include a starter motor 64 operable to rotate the linkage 56 through the gear 60. A clutch 66 can be positioned between the starter motor 64 and the linkage 56.

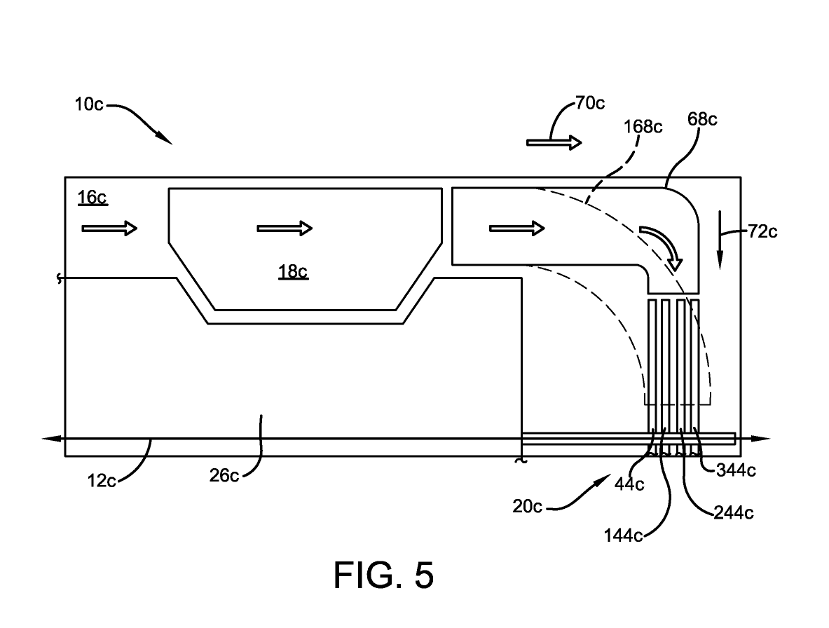

Referring now to FIG. 5, a turbine engine 10c extends along a longitudinal axis 12c and includes a compressor section 16c, a combustor section 18c, and a turbine section 20c. A shaft 26c extends along the axis 12c and interconnects the compressor section 16c and the turbine section 20c so that that rotation of the turbine section 20c drives the compressor section 16c in rotation.

In operation, compressed air enters the combustion section 18c, is intermixed with fuel, and ignited and burned, generating a hot gaseous fluid stream. The hot gaseous fluid stream exits the combustor section 18c and is fed into the turbine section 20c. The turbine section 20c is operable to extract energy from the combustion gases to generate power. The power can be applied to power the turbine engine 10 and/or can be applied to other uses.

The exemplary turbine section 20c includes a plurality of spaced disks 44c, 144c, 244c, 344c disposed for rotation about the axis 12c. The combustion gases are operable to drive the plurality of spaced disks in rotation by engaging the planar surfaces. Rotation of the discs generates rotational power.

In the embodiment shown in FIG. 5, the exemplary turbine engine 10c includes a duct 68c can be configured to divert flow of combustion gases from the combustor section 18c from a first direction along a longitudinal axis 12c. The first direction is referenced at 70c in FIG. 5. The duct 68c can be configured to divert flow to a second direction transverse to the longitudinal axis 12c. The first direction is referenced at 72c in FIG. 5. The exemplary second direction 72c is perpendicular to the longitudinal axis 12c. An alternative duct 168c is shown in phantom in FIG. 5 in which the diversion of flow is more gradual and can be helical.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A turbine engine comprising:
a compressor section operable to compress fluid;
a combustor section positioned downstream of said compressor section and defining a combustion chamber operable to receive compressed fluid from said compressor section; and
at least one turbine section positioned downstream of said combustor section and operable to receive combustion gases from said combustion chamber, wherein said at least one turbine section includes a plurality of spaced disks disposed for rotation and each having planar surfaces, said combustion gases operable to drive said plurality of spaced disks in rotation by engaging said planar surfaces.

2. The turbine engine of claim 1 wherein said at least one turbine section further comprises a plurality of turbine sections each including a respective plurality of spaced disks disposed for rotation.

3. The turbine engine of claim 2 wherein at least two of said plurality of turbine sections are arranged to rotate on different axes.

4. The turbine engine of claim 3 wherein a first of said at least two of said plurality of turbine sections is arranged to rotate on a first axis and a second of said at least two of said plurality of turbine sections is arranged to rotate on a second axis and wherein said first axis and said second axis are parallel to one another.

5. The turbine engine of claim 3 wherein a first of said at least two of said plurality of turbine sections is arranged to rotate on a first axis and a second of said at least two of said plurality of turbine sections is arranged to rotate on a second axis and wherein said first axis and said second axis are transverse to one another.

6. The turbine engine of claim 3 wherein a first of said at least two of said plurality of turbine sections is arranged to rotate on a first axis and a second of said at least two of said plurality of turbine sections is arranged to rotate on a second axis and a third of said at least two of said plurality of turbine sections is arranged to rotate on a third axis, wherein said first axis and said second axis are parallel to one another and said first axis and said second axis are transverse to one another.

7. The turbine engine of claim 3 wherein a first of said at least two of said plurality of turbine sections is arranged to rotate on a first axis and a second of said at least two of said plurality of turbine sections is arranged to rotate on a second axis, wherein said combustion gases move in first direction and said first axis and said second axis are spaced from one another along said first direction.

8. The turbine engine of claim 1 wherein said combustor section defines a single and continuous exit port and wherein respective radial edges of said plurality of spaced disks are substantially aligned on a center of said exit port.

9. The turbine engine of claim 1 wherein said combustor section defines a plurality of exit ports and wherein said at least one turbine section further comprises a plurality of turbine sections respectively positioned at each of said plurality of exit ports and each including a respective plurality of spaced disks disposed for rotation.

10. The turbine engine of claim 9 wherein each of said plurality of turbine sections are mounted on a common shaft.

11. The turbine engine of claim 1 wherein said combustor section defines at least one exit port having a rectangular perimeter.

12. The turbine engine of claim 1 further comprising:
a linkage operable to transmit rotation between said compressor section and said at least one turbine section.

13. The turbine engine of claim 12 further comprising:
a starter motor operable to rotate said linkage.

14. The turbine engine of claim 12 further comprising:
a clutch positioned between said starter motor and said linkage.

15. The turbine engine of claim 1 further comprising:
a duct configured to divert flow of combustion gases from said combustion chamber from a first direction along a longitudinal axis of said turbine engine to a second direction transverse to said longitudinal axis.

16. The turbine engine of claim 15 wherein said second direction is perpendicular to said longitudinal axis.
